(19) United States
(12) Patent Application Publication
(10) Pub. No.: US 2012/0196491 A1
(43) Pub. Date: Aug. 2, 2012

(54) ELECTRICAL CONNECTOR

(75) Inventor: Yong Jun Dai, Keelung (TW)

(73) Assignee: LOTES CO., LTD., Keelung (TW)

(21) Appl. No.: 13/177,244

(22) Filed: Jul. 6, 2011

(30) Foreign Application Priority Data
Jan. 28, 2011 (CN) 201120031882.X

(51) Int. Cl. H01R 9/24

(52) U.S. Cl. 439/709

(57) ABSTRACT

An electrical connector. In one embodiment, the electrical connector includes: an insulating body, having a plurality of receiving slots formed through the insulating body, in which each receiving slot has two first inner walls disposed opposite to each other, and a plurality of terminals, each terminal correspondingly fixed in each receiving slot and each terminal having a retaining portion, in which a first transition portion extends downwards from the retaining portion and urges against one first inner wall, a first contact portion extends downwards from the first transition portion, a second transition portion extends upwards from the first contact portion and urges against the other first inner wall, and a second contact portion extends upwards from the second transition portion.

### CROSS-REFERENCE TO RELATED APPLICATION

This non-provisional application claims priority under 35 U.S.C. §119(a) on Patent Application No. 201120031882.X filed in P.R. China on Jan. 28, 2011, the entire contents of which are hereby incorporated by reference.

### FIELD OF THE INVENTION

The present invention relates to an electrical connector, and more particularly to an electrical connector for electrically connecting a chip module to a circuit board.

### BACKGROUND OF THE INVENTION

A Land Grid Array (LGA) connector in the prior art is electrically connected to a chip module in a press-fit manner at an upper end and is electrically connected to a circuit board by soldering at a lower end. However, when the LGA connector is soldered in a reflow oven, the insulating body of the LGA connector is easily deformed to produce warpage, thus resulting in a poor soldering performance at the lower end and causing missing solder or false soldering problem.

Then, a universal electrical connector has been proposed in the industry, for electrically connecting the chip module to the circuit board. The electrical connector includes an insulating body, a plurality of receiving slots formed through the insulating body, and a plurality of terminals respectively accommodated in the receiving slots correspondingly. Each terminal includes: a base, in interference-fit with the receiving slot, a first contact arm, extending upwards and bent from the base, in which a first contact portion is disposed at a tail end of the first contact arm, exceeds a top surface of the insulating body and is used for electrically connecting the chip module, and a second contact arm, extending downwards and bent from the base, in which a second contact portion is disposed at a tail end of the second contact arm, exceeds a bottom surface of the insulating body and is electrically press-fit on the circuit board. The first contact portion and the second contact portion are located on different sides of the base.

However, the electrical connector has deficiencies in structure and these deficiencies cause the following problems.

1. When the electrical connector is in use, the first contact portion receives a downward pressure and meanwhile the second contact portion receives an upward pressure. However, as the first contact portion and the second contact portion are located on different sides of the base, the above two pressures produce a torque to enable the terminals to rotationally deform, so that the terminals undergo large longitudinal deformation. Therefore, the first contact portion and the second contact portion undergo large longitudinal sliding movement, that is, the positions of the first contact portion and the second contact portion change greatly, which causes the difficulty in the design of contacts on the chip module and the circuit board.

2. The terminals are fixed in the receiving slots by means of interference-fit of the bases and the receiving slots. When the terminals are inserted in the receiving slots, a large force is required for insertion, which causes large deformation of the terminals.

Therefore, a heretofore unaddressed need exists in the art to address the aforementioned deficiencies and inadequacies.

### SUMMARY OF THE INVENTION

In one aspect, the present invention is directed to an electrical connector, which reduces the longitudinal sliding movement of the terminals and can electrically contact with a chip module and a circuit board accurately.

In one embodiment, an electrical connector is provided. The electrical connector includes: an insulating body, having a plurality of receiving slots formed through the insulating body, in which each receiving slot has two first inner walls disposed opposite to each other, and a plurality of terminals, each terminal correspondingly fixed in each receiving slot and each terminal having a retaining portion, in which a first transition portion extends downwards from the retaining portion and urges against one first inner wall, a first contact portion extends downwards from the first transition portion, a second transition portion extends upwards from the first contact portion and urges against the other first inner wall, and a second contact portion extends upwards from the second transition portion.

Compared with the prior art, in one aspect of the present invention, in the electrical connector, the terminal has the first transition portion, extending downwards from the retaining portion, the first contact portion, extending downwards from the first transition portion, the second transition portion, extending upwards from the first contact portion, in which the first transition portion and the second transition portion are located on different sides of the first contact portion, and the second contact portion, extending upwards from the second transition portion, when the terminals are received in the insulating body, the first transition portion urges against one first inner wall, and the second transition portion urges the other first inner wall.

When the chip module and the circuit board are in press-fit with the electrical connector of the present invention from the above and below, the first contact portion and the second contact portion respectively receive a pressure, as the first transition portion and the second transition portion respectively urge against each first inner wall, and the first contact portion and the second contact portion undergo small sliding movement in a longitudinal direction, that is, the positions of the first contact portion and the second contact portion do not change much, which is easy for the design of contacts on the chip module and the circuit board. The contacts of the circuit board and the chip module may be designed relatively small, thereby reducing the manufacturing cost of the electrical connector.

Moreover, the terminals are fixed in the receiving slots by limiting the retaining portions in the retaining slots. Therefore, when the terminals are inserted in the receiving slots, a small force is required for insertion, so that the terminals do not easily undergo deformation. Additionally, the terminals of the electrical connector are simply formed by bending, thereby reducing the manufacturing difficulty and the manufacturing cost.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a three-dimensional assembled view of an electrical connector in one embodiment of the present invention;

FIG. 2 is a schematic view of terminals installed in receiving slots of the electrical connector in one embodiment of the present invention;

FIG. 3 is a schematic three-dimensional view of a terminal of the electrical connector in one embodiment of the present invention;

FIG. 4 is a sectional view of the electrical connector in one embodiment of the present invention in electrical contact with a chip module and a circuit board; and

FIG. 5 is a sectional view of the electrical connector in one embodiment of the present invention.

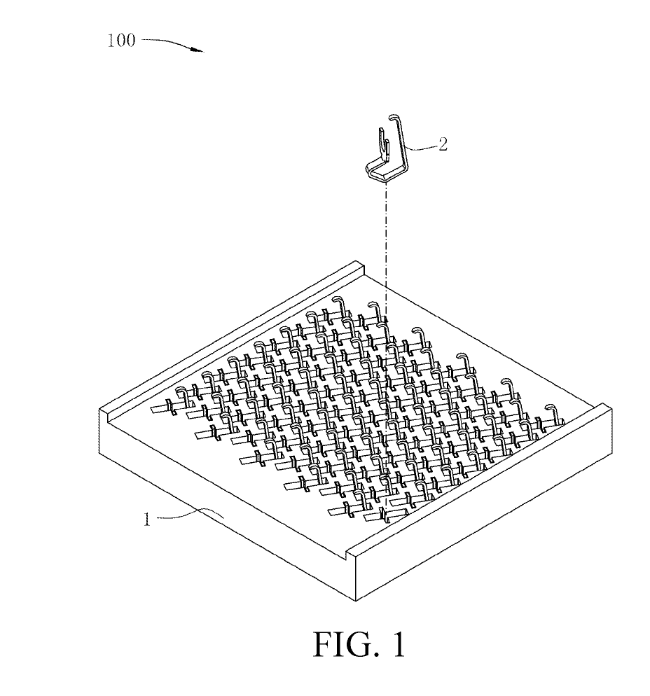

List of Reference Numerals in FIGS. 1-5:

| | | | | | |
|---|---|---|---|---|---|
| Electrical connector | 100 | Insulating body | 1 | Receiving slot | 11 |
| First inner wall | 111 | Second inner wall | 112 | Retaining slot | 113 |
| Terminal | 2 | Retaining portion | 21 | base | 211 |
| Fixing arm | 212 | First transition portion | 22 | First extending portion | 23 |
| First contact portion | 24 | First elastic arm | 25 | Second transition portion | 26 |
| Second extending portion | 27 | Second contact portion | 28 | Second elastic arm | 29 |
| Chip module | 3 | First conductive sheet | 41 | Circuit board | 4 |
| Second conductive sheet | 31 | | | | |

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

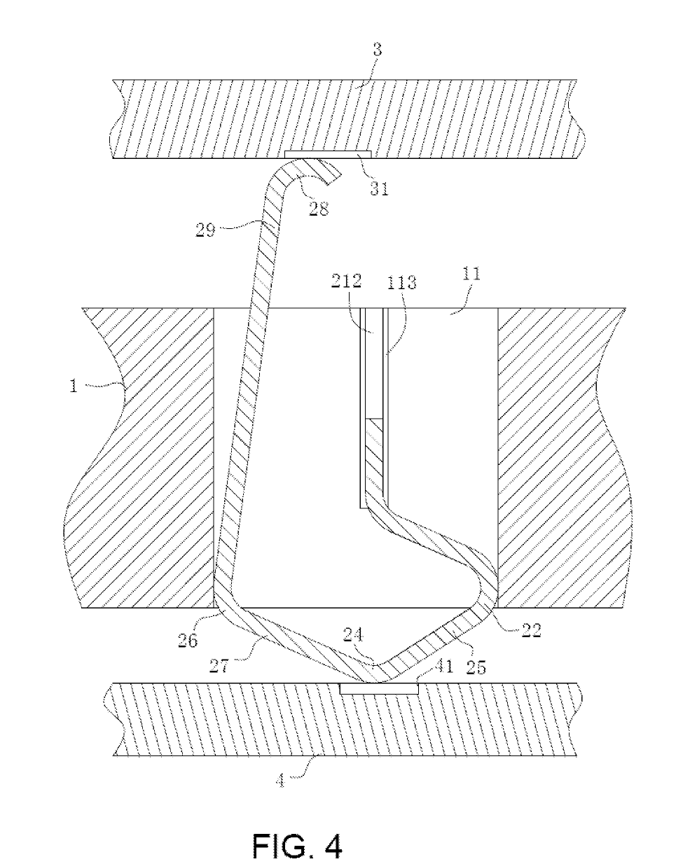

Referring to FIG. 1 and FIG. 4, the electrical connector 100 of one embodiment of the present invention is used for electrically connecting a chip module 3 to a circuit board 4, and includes an insulating body 1 and a plurality of terminals 2 disposed in the insulating body 1.

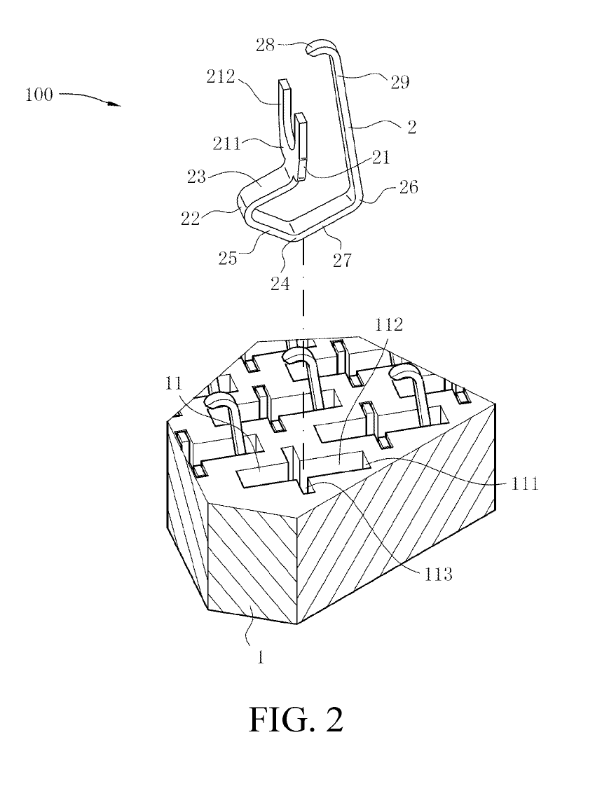

Referring to FIG. 2, the insulating body 1 has a plurality of receiving slots 11 formed through the insulating body 1. The receiving slots 11 are arranged in a staggered manner on the insulating body 1, so that the receiving slots 11 are arranged on the insulating body 1 more densely, thereby increasing the arrangement density of the terminals 2 on the insulating body 1. Each receiving slot 11 has two first inner walls 111 disposed opposite to each other and two second inner walls 112 disposed opposite to each other.

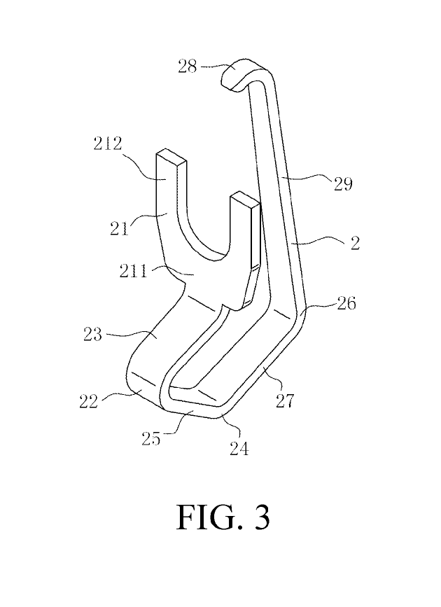

Referring to FIG. 3, each terminal 2 is correspondingly fixed in each receiving slot 11. Each terminal 2 has a retaining portion 21, and the retaining portion 21 has a base 211 and two fixing arms 212 extending upwards from the base 211. A first transition portion 22 extends downwards from the retaining portion 21 and urges against one first inner wall 111. A first extending portion 23 extends downwards from the retaining portion 21 and connects the first transition portion 22 and the retaining portion 21. The two second inner walls 112 are respectively recessed with a retaining slot 113, the retaining portion 21 enters the two retaining slots 113, and the two fixing arms 212 are respectively correspondingly retained in the two retaining slots 113.

A first contact portion 24 extends downwards from the first transition portion 22, and a first elastic arm 25 extends downwards from the first transition portion 22 and connects the first contact portion 24 and the first transition portion 22. The first extending portion 23, the first transition portion 22 and the first elastic arm 25 are located in front of the retaining portion 21. A second transition portion 26 extends upwards from the first contact portion 24 and urges against the other first inner wall 111. The first transition portion 22 is slightly higher than the second transition portion 26.

A second extending portion 27 extends upwards from the first contact portion 24 and connects the second transition portion 26 and the first contact portion 24. A second contact portion 28 extends upwards from the second transition portion 26. A second elastic arm 29 extends upwards from the second transition portion 26 and connects the second contact portion 28 and the second transition portion 26. The second extending portion 27, the second transition portion 26 and the second elastic arm 29 are located behind the retaining portion 21. The first contact portion 24 and the second contact portion 28 are respectively exposed below and above the receiving slot 11.

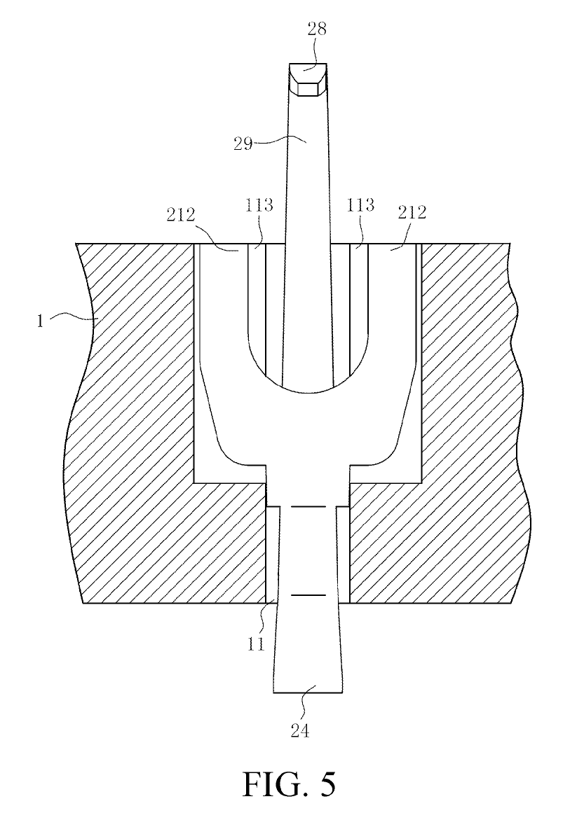

During assembly, referring to FIG. 2 and FIG. 5, the process of installing the terminal 2 in the insulating body 1 in one embodiment is described as follows. Firstly, the terminal 2 is placed right above the receiving slot 11. The terminal 2 is moved towards the receiving slot 11, the retaining portion 21 enters the two retaining slots 113, and the two fixing arms 212 are respectively correspondingly retained in the two retaining slots 113. At the same time, the second elastic arm 29, the first extending portion 23, the first transition portion 22, and the second transition portion 26 are accommodated in the receiving slot 11.

The first transition portion 22 and the second transition portion 26 respectively urge against the two first inner walls 111 of the receiving slot 11 and meanwhile, the width of the two retaining slots 113 is substantially the same as the thickness of the two fixing arms 212, so the retaining portion 21 is limited in a thickness direction. The width of the first extending portion 23 is substantially the same as the width of the first inner wall 111, so the terminal 2 is limited in the width direction of the first extending portion 23.

Referring to FIG. 2 and FIG. 4, the first contact portion 24 and the second contact portion 28 are exposed below and above the receiving slot 11, so as to respectively electrically contact a first conductive sheet 41 of the circuit board 4 and a second conductive sheet 31 of the chip module 3. When the chip module 3 and the circuit board 4 press against the electrical connector 100, the first contact portion 24 and the second contact portion 28 respectively receive a pressure, as the first transition portion 22 and the second transition portion 26 respectively urge against each first inner wall 111, the first contact portion 24 and the second contact portion 28 undergo relatively small sliding movement in a longitudinal direction, in other words, the positions of the first contact portion 24 and the second contact portion 28 do not change much. Therefore, the first conductive sheet 41 of the circuit board 4 and the second conductive sheet 31 of the chip module 3 may be made relatively small.

Based on the above, the electrical connector of the present invention, among other things, has the following beneficial effects.

1. When the terminals are received in the insulating body, the first transition portion and the second transition portion respectively urge against the two first inner walls, that is, the first transition portion and the second transition portion are located on different sides of the first contact portion. When the chip module and the circuit board are in press-fit with the electrical connector of the present invention from the above and below, the first contact portion and the second contact portion respectively receive a pressure, as the first transition portion and the second transition portion respectively urge against each first inner wall, and the first contact portion and the second contact portion undergo small sliding movement in a longitudinal direction, that is, the positions of the first contact portion and the second contact portion do not change much. Therefore, the first conductive sheet of the circuit board and the second conductive sheet of the chip module may be made relatively small, thereby reducing the manufacturing cost of the electrical connector.

2.The terminals are fixed by limiting the retaining portions in the retaining slots, that is, the terminals and the retaining slots are in clearance-fit instead of interference-fit. Therefore, when the terminals are inserted in the receiving slots, a small force is required for insertion, so that the terminals undergo small deformation.

3. The receiving slots are arranged in a staggered manner on the insulating body, so the receiving slots are arranged on the insulating body more densely, thereby increasing the arrangement density of the terminals on the insulating body.

4. The terminals of the electrical connector of the present invention are simply formed by bending, thereby reducing the manufacturing difficulty and the manufacturing cost.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body, having a plurality of receiving slots formed through the insulating body, wherein each receiving slot has two first inner walls disposed opposite to each other; and
a plurality of terminals, each terminal correspondingly fixed in each receiving slot and each terminal having a retaining portion, wherein a first transition portion extends downwards from the retaining portion and urges against one first inner wall, a first contact portion extends downwards from the first transition portion, a second transition portion extends upwards from the first contact portion and urges against the other first inner wall, and a second contact portion extends upwards from the second transition portion.

2. The electrical connector according to claim 1, wherein each receiving slot has two second inner walls disposed opposite to each other, the two second inner walls are respectively recessed with a retaining slot, and the retaining portion enters and is retained in the two retaining slots.

3. The electrical connector according to claim 2, wherein the retaining portion has a base and two fixing arms extending upwards from the base, and the two fixing arms are respectively retained in the two retaining slots.

4. The electrical connector according to claim 1, wherein a first extending portion extends downwards from the retaining portion and connects the first transition portion and the retaining portion, and a first elastic arm extends downwards from the first transition portion and connects the first contact portion and the first transition portion.

5. The electrical connector according to claim 4, wherein the first extending portion, the first transition portion and the first elastic arm are located in front of the retaining portion.

6. The electrical connector according to claim 1, wherein a second extending portion extends upwards from the first contact portion and connects the second transition portion and the first contact portion, and a second elastic arm extends upwards from the second transition portion and connects the second contact portion and the second transition portion.

7. The electrical connector according to claim 6, wherein the second extending portion, the second transition portion and the second elastic arm are located behind the retaining portion.

8. The electrical connector according to claim 1, wherein the first transition portion is slightly higher than the second transition portion.

9. The electrical connector according to claim 1, wherein the first contact portion and the second contact portion are respectively exposed below and above the receiving slot.

10. The electrical connector according to claim 1, wherein the receiving slots are arranged in a staggered manner on the insulating body.
